(19) United States
(12) Patent Application Publication
(10) Pub. No.: US 2024/0162517 A1
(43) Pub. Date: May 16, 2024

(54) BATTERY RECYCLING APPARATUS AND METHOD

(71) Applicant: FLOW CELL TECH, LLC, Noank, CT (US)

(72) Inventor: Michael L. Perry, Noank, CT (US)

(21) Appl. No.: 18/389,585

(22) Filed: Nov. 14, 2023

Related U.S. Application Data
(60) Provisional application No. 63/383,556, filed on Nov. 14, 2022.

(51) Int. Cl. H01M 10/54; B09B 3/70

(52) U.S. Cl. CPC H01M 10/54; B09B 3/70; B09B 2101/16

(57) ABSTRACT

Disclosed is a battery recycling process wherein an electrochemical flow cell reactor is used to regenerate a reducing agent in an efficient manner. The reactor is decoupled from a hydrometallurgical process in which the reducing agent is used to promote the leaching and reduction of used battery materials in a stirred-tank reactor, such that these two potentially continuous reactors can be operated at independent rates. Since the electrochemical reactor effectively employs forced convective flow, it enables operation at high conversion rates with minimal overpotential and can also be preferentially operated when electrical energy is readily available while the stirred-tank reactor can be operated essentially continuously at a relatively low rate, which enables this equipment to be sized for the desired average energy consumption rate. These features reduce the capital and operation costs relative to electrochemical-based hydrometallurgical process systems taught by others.

### CROSS-REFERENCE TO RELATED APPLICATIONS

This application claims the benefit of U.S. Provisional Patent Application No. 63/383,556, entitled “NOVEL BATTERY RECYCLING SYSTEM AND METHOD,” filed Nov. 14, 2022, which is incorporated by reference herein in its entirety.

### BACKGROUND OF THE INVENTION

This disclosure relates generally to recycling battery materials and, more specifically, to using an electrochemical-based hydrometallurgical process.

To enable a Clean Energy future, a large number of batteries are required and a large number of those batteries are expected to be lithium-ion batteries (LiBs). These future LiB-production volumes may result in supply problems, especially with cobalt (Co), nickel (Ni), and lithium (Li). Therefore, cost-effective and sustainable battery recycling is vital since this can mitigate the looming supply issues, as well as make lithium-ion batteries a more circular economy. Current LiB-recycling processes use large amounts of energy (e.g., pyrometallurgical processes), generate wastes (e.g., air emissions from pyrometallurgical processes) and/or require excessive amounts of reagents (e.g., hydrometallurgical processes).

Although the use of electrochemical-based hydrometallurgical processes to recycle battery materials have been taught, such as in US Patent Application US20220223932A1, the electrochemical process is a batch process, which has inherent drawbacks from an operational and capital cost perspective. These drawbacks include poor electrochemical reaction rates due to continuously decreasing reactant concentrations in the minimal convective flow to minimize mass transport losses in a batch reactor.

Another drawback is that previous systems are not designed to operate the electrochemical process at a rate that can be independent of the hydrometallurgical processes so that operational and capital costs can be reduced, as will be shown below.

### SUMMARY OF THE INVENTION

Disclosed is a battery recycling process where an electrochemical flow cell reactor is used to regenerate a reducing agent in an efficient manner, which reactor is decoupled from a hydrometallurgical process in which this reducing agent is used to promote the leaching and reduction of used battery materials in a stirred-tank reactor, such that these two potentially continuous reactors can be operated at independent rates. Since the electrochemical reactor effectively employs forced convective flow it enables operation at high conversion rates with minimal overpotential and can also be preferentially operated when electrical energy is readily available while the stirred-tank reactor can be operated essentially continuously at a relatively low rate, which enables this equipment to be sized for the desired average energy consumption rate. These features reduce the capital and operation costs relative to electrochemical-based hydrometallurgical process systems taught by others.

In accordance with one aspect of the disclosure, a system for recovering an active material from a rechargeable battery is disclosed. The system includes a hydrometallurgical reactor configured to contact the active material with an aqueous electrolyte comprising an acid and a reducing agent. The system further includes an electrochemical flow cell comprising a cathode, an anode, and a separator disposed therebetween. The cathode receives the aqueous electrolyte, and the anode receives a second fluid. The system further includes a separator apparatus configured to separate and recover the active material from the aqueous electrolyte, and recirculate the aqueous electrolyte to the electrochemical flow cell.

In one embodiment, the system further includes a storage vessel for the aqueous electrolyte with reducing agent, and a second storage vessel for the oxidized reducing agent in the aqueous electrolyte.

In another embodiment, the reactor is configured to operate at a rate that is independent of a rate of operation of the electrochemical flow cell, which is enabled by the volume of aqueous electrolyte in the first and second storage vessels.

In yet another embodiment, the electrochemical flow cell is configured to operate at higher rates when electricity rates are low and is run at lower rates, or even stopped, when the costs of electricity are high.

In one example, the reducing agent are ferrous ions and the oxidized reducing agent are ferric ions.

In another example, the acid is sulfuric acid.

In yet another example, the second fluid is water, which is oxidized to form molecular oxygen and protons on the anode.

In yet another example, the second fluid is hydrogen, which is oxidized to form protons on the anode.

In yet another example, the active material is black mass from recycled lithium-ion batteries.

In accordance with another aspect of the disclosure, a method for recovering an active material from a rechargeable battery is disclosed. The method includes a first process and a second process. The first process includes the steps of placing the active material from a rechargeable battery in a reactor and contacting the active material with an aqueous electrolyte comprising an acid and a reducing agent; reducing the active material by oxidation of the reducing agent; dissolving the active material into the aqueous electrolyte; and separating the active material from the oxidized reducing agent in the aqueous electrolyte. The second process includes the steps of circulating the oxidized reducing agent in the aqueous electrolyte through a cathode of an electrochemical flow cell, the electrochemical flow cell comprising the cathode, an anode, and a separator disposed therebetween; applying a potential to the electrochemical flow cell sufficient to reduce the oxidized reducing agent while simultaneously oxidizing a second fluid on the anode; and circulating the regenerated aqueous electrolyte with reducing agent from the second process to the reactor in the first process.

In one embodiment, the method further includes a first storage vessel for the aqueous electrolyte with reducing agent, and a second storage vessel for the oxidized reducing agent in the aqueous electrolyte.

### BRIEF DESCRIPTION OF DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a block diagram of a system for recovering an active material from a rechargeable battery, in accordance with one embodiment of the invention;

FIG. 2 schematically depicts the electrochemical flow cell shown in FIG. 1; and

FIG. 3 is a block diagram collectively presenting a flow chart illustrating an exemplary embodiment of a method for recovering an active material from a rechargeable battery.

### DETAILED DESCRIPTION OF THE INVENTION

An electrochemical-based hydrometallurgical process provides a method to minimize the energy and reagents required to recycle batteries. However, the capital cost of the electrochemical systems proposed to date are excessive. Electrochemical-based processes with lower capital and operating costs are therefore needed to make this a viable lithium battery recycling method.

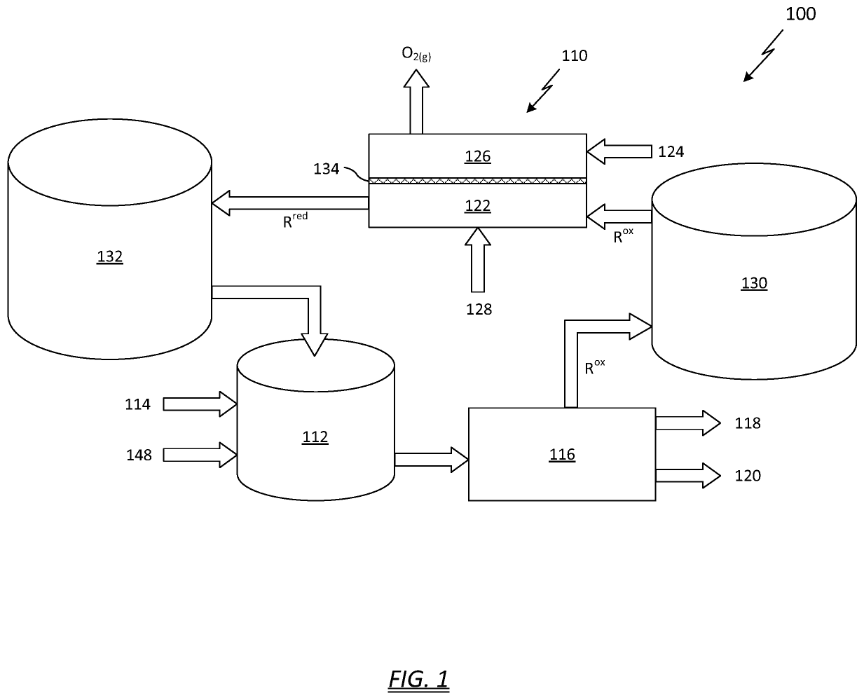

Referring to FIG. 1, disclosed herein is a battery recycling system 100 utilizing an electrochemical flow cell 110, or flow cell reactor, to regenerate a reducing agent (R^{red}) in an efficient manner. The flow cell reactor 110 may be decoupled from a hydrometallurgical process wherein the reducing agent (R^{red}) is used to promote the leaching and reduction of used battery materials in a hydrometallurgical reactor 112, such that the two potentially continuous reactors can be operated at independent rates. Since the electrochemical reactor 110 effectively employs forced convective flow, it enables operation at high conversion rates with minimal overpotential and may also be preferentially operated when electrical energy is readily available. Conversely, the hydrometallurgical reactor 112 may be operated essentially continuously at a relatively low rate, which enables the equipment to be sized for the desired average energy consumption rate.

The battery recycling system 100 may be characterized by two processes, which may operate independently. In the first process, used battery materials from a rechargeable battery, such as black mass, may be placed in the hydrometallurgical reactor 112. The used battery material includes at least one active material 114, such as lithium (Li), cobalt (Co), nickel (Ni), copper (Cu), and/or manganese (Mn). The active material 114 in the hydrometallurgical reactor 112 is contacted with an aqueous electrolyte comprising an acid and the reducing agent R^{red}, such that the active material 114 is reduced by oxidation of the reducing agent (R^{red}→R^{ox}). The active material 114 is dissolved into the aqueous electrolyte and passed from the hydrometallurgical reactor 112 to a separator apparatus 116, which separates and recovers the desired products (i.e., recovered materials 118 such as, but not limited to, Cu, Li, Ni, Co, and Mn), discharges any waste streams 120, and passes an enriched concentration of the oxidized reducing agent (R^{ox}) to the second process. In one example, the reducing agent are ferrous ions and the oxidized reducing agent are ferric ions having a concentration within a range of about 0.01M to 2M. In another example, the acid is sulfuric acid having a concentration within a range of about 0.1M to 5M.

In the second process, the oxidized reducing agent (R^{ox}) in the aqueous electrolyte is circulated through the cathode 122 of the electrochemical flow cell 110, while a second fluid 124 flows through the anode 126. An electrical potential 128 is applied to the flow cell 110 sufficient to reduce the oxidized reducing agent (R^{ox}→R^{red}) while simultaneously oxidizing the second fluid on the anode 126. The regenerated aqueous electrolyte with reducing agent (R^{red}) from the second process is then circulated to the hydrometallurgical reactor 112 in the first process.

In one embodiment, the battery recycling system 100 may further include an oxidized electrolyte storage tank 130 to store the enriched concentration of oxidized reducing agent (R^{ox}) discharged from the separator apparatus 116. The system 100 may further include a reduced electrolyte storage tank 132 to store the reducing agent (R^{red}) discharged from the cathode 122 of the electrochemical flow cell 110. The storage tanks 130, 132 may be fabricated from materials that are compatible with electrolyte solutions, such as, for example, plastic tanks for acidic electrolytes. The volume of the tanks 130, 132 may be approximately equal, such that one tank can be almost empty when the other tank is almost full. The total volume of the tanks 130, 132 may be significantly larger than the volume of the hydrometallurgical reactor 112 to enable long periods of recycling used battery materials without regenerating a reducing agent in the electrochemical flow cell 110. In one example, the total volume of the tanks 130, 132 may be more than ten times the volume of the hydrometallurgical reactor 112. In some embodiments, the storage tanks 130, 132 may include a plurality of tanks.

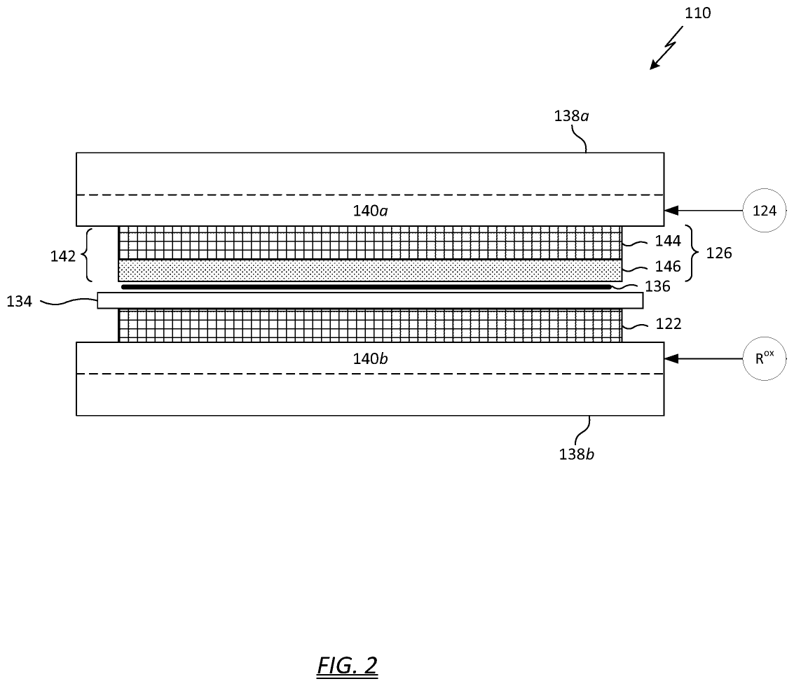

Referring to FIG. 2, the electrochemical flow cell 110 is shown in greater detail. The flow cell 110 includes an anode 126 and a cathode 122 separated by a separator 134. In the illustrated example, the separator 134 is a polymer electrolyte membrane (PEM) that has high selectivity for transport of the desired charge carrier, H⁺. An anode catalyst layer 136 abuts the anode side of the membrane 134. The catalyst is selected to promote the desired reaction, and may comprise several layers. In one example, the anode catalyst layer 136 may be iridium oxides or platinum oxides of platinum metal group alloys. These catalysts may be supported, for example on metal oxides or on carbon, depending on the desired reaction. The anode catalyst layer 136 may also include an ionomer (i.e., a polymer with ionic groups) to serve as an ionic conductor and binder.

Bipolar plates 138 include reactant flow channels or flow fields 140 to direct reactants to the reaction sites on the membrane 134. The anode flow field 140a directs the second fluid 124, which may be water in one example, through one or more porous transport layers 142 to the catalyst layer 136. In the illustrated example, the porous transport layer 142 comprises a macroporous layer 144, or diffusion layer, and a microporous layer 146. The porous transport layer 142 may be formed of corrosion-resistant and electrically-conductive material, such as titanium meshes, felts or foams. In another example, the second fluid 124 may be hydrogen and these layers may be comprised of carbon or graphite materials since a relatively high electrochemical potential is not required in this case.

The cathode flow field 140b directs the oxidized reducing agent (R^{ox}) through the cathode 122. The cathode 122 may be formed of a porous carbon layer, such as carbon paper, felt or cloth.

The anode bipolar plate 138a may be formed of a corrosion-resistant and electrically-conductive material, such as titanium or coated stainless steel if the second fluid 124 is water. Alternatively, the anode bipolar plate 138a may be formed of graphite, or a graphite composite, if the second fluid 124 is hydrogen. The cathode bipolar plate 138b may also be formed of a corrosion-resistant and electrically-conductive material, such as titanium, coated stainless steel, graphite, or a graphite composite. In one embodiment, the cathode flow field 140b includes interdigitated flow fields to minimize mass-transport losses with relatively low pressure drop, even with relative thin electrodes and porous transport layers 142 (which enables lower Ohmic losses). Interdigitated flow field arrangements differ from conventional flow field arrangements by directing fluid to enter the inlet of one channel, but exit the outlet of another channel. Fluid flowing in each inlet channel is effectively diverted into two separate outlet channels with approximately one-half of the flow from each inlet channel going into a corresponding outlet channel.

Returning now to FIG. 1, the hydrometallurgical reactor 112 may be formed of materials that are compatible with electrolyte solutions, such as plastic tanks for acidic solutions. In one embodiment, the hydrometallurgical reactor 112 is a continuous stirred tank reactor with an average residence time that is sufficient to enable the desired reduction of the used battery materials. In another embodiment, the hydrometallurgical reactor 112 may be comprised of one or more tanks in series or in parallel. And, in one example, the hydrometallurgical reactor 112 may comprise conical-bottom tanks using high-shear agitation.

The desired reactions in the electrochemical flow cell reactor 110 are as follows, preferably operated at 40° C. to 80° C., but can be operated at room temperature and up to 95° C.

Anode:2H₂O₍ₗ₎→O_{2(g)}+4H⁺+4e⁻ (1)

Cathode:4R^{ox}+4H⁺+4e⁻→4^{Red} (2)

Overall:2H₂O₍ₗ₎+4R^{ox}→O_{2(g)}+4R^{red} (3)

In one exemplary embodiment, Fe²⁺ may be used as the reducing agent, and the cathode reaction is:

Cathode:4Fe³⁺+4H⁺+4e⁻→4Fe²⁺ (4)

In another embodiment, sulfuric acid may be used as the supporting electrolyte, and the cathode reaction is:

Cathode:2Fe₂(SO₄)₃+4H⁺+4e⁻→4FeSO₄+2H₂SO₄ (5)

In this case, the overall reaction is:

2Fe₂(SO₄)₃+2H₂O₍ₗ₎→4FeSO₄+O_{2(g)}+2H₂SO₄ (6)

In another embodiment, as an alternative to splitting water on the anode, the anode may be fed hydrogen 124. The reactions are:

Anode:2H_{2(g)}→4H⁺+4e⁻ (7)

Cathode:4R^{ox}+4H⁺+4e⁻→4R^{red} (8)

Overall:2H_{2(g)}+4R^{ox}→4R^{red} (9)

If Fe²⁺ is used as the reducing agent and sulfuric acid is the supporting electrolyte, then the cathode reaction is the same as above (Equation 5), and the overall reaction with hydrogen on the anode is:

Overall:2Fe₂(SO₄)₃+2H_{2(g)}→4FeSO₄+2H₂SO₄ (10)

The desired reactions in the hydrometallurgical reactor 112 are as follows, preferably operated at 60° C. to 95° C. Leaching of the lithium-ion battery active materials:

lithium-ion battery materials in aqueous solution+R^{ox}→lithium-ion battery active materials with reduced ions+R^{red} (11)

In one example, with Fe²⁺ as the reducing agent and nickel manganese cobalt (NMC)-type lithium-ion battery materials, where the NMC materials are converted to their more aqueous-soluble forms (e.g., Mn⁴⁺ and Co²⁺ to Mn′ and Co²⁺, respectively):

LiNiₓMn_{y}Co_{z}O₂+Fe²⁺+4H⁺→Li⁺+XNi²⁺+YMn²⁺+ZCo²⁺+Fe³⁺+2H₂O, where X+Y+Z=1 (12)

LiNiₓMn_{y}Co_{z}O₂+2FeSO₄+2.5H₂SO₄→0.5Li₂SO₄+XNiSO₄+YMnSO₄+ZCoSO₄+Fe₂(SO₄)₃+2H₂O (13)

Embodiments of the present invention offer several possible reducing agents for the acid leaching step in the hydrometallurgical reactor 112. In one example, hydrogen peroxide (H₂O₂) provides an interesting candidate because it contains oxygen in an oxidation state midway between molecular oxygen and water. This means H₂O₂ can act as an oxidizing agent or a reducing agent. Below are the chemical reactions with associated electrochemical potential E⁰ expressed in volts standard hydrogen electrode (V SHE):

Oxidizing Agent:H₂O₂+2H⁺¹+2e⁻¹→2H₂O E⁰=1.776V SHE (14)

Reducing Agent:H₂O₂→O₂+2H⁺¹+2e⁻¹E⁰=0.682V SHE (15)

In another example, iron has a similar redox potential as H₂O₂ acting as a reducing agent:

Fe²⁺→Fe³⁺+e⁻¹E⁰=0.771V SHE (16)

It is therefore readily apparent that either can be effective at reducing Co⁺³ and Mn⁺⁴ into their soluble forms, Co⁺² and Mn⁺², based on the standard redox potentials:

Co³⁺+e⁻¹→Co²⁺E⁰=1.92V SHE (17)

MnO₂+4H⁺¹+2e⁻¹→Mn²⁺+2H₂O E⁰=1.224V SHE (18)

Other metals or metal complexes having an E⁰ less than approximately 1.2 V SHE with two non-zero oxidation states (since plating of metal is not desired here) can potentially serve as reducing agents. Two examples include V(III)/V(IV) with E⁰=0.34V, and ferro/ferri-cyanide at low pH with E⁰≈0.3V. However, iron is low-cost, abundant, and is present in the feedstock, making it a better choice. In another example, Fe(II)/Fe(III) may be a preferred choice since, if copper (Cu) metal is present, which is expected, it should result in regeneration of the Fe(II) in the hydrometallurgical reactor 112, since Cu(II)/Cu(0) E⁰=0.34V and Cu(I)/Cu(0) with E⁰=0.52V. Cu should be removed downstream of the hydrometallurgical reactor 112. Additionally, the redox kinetics of the Fe(II)/Fe(III) reaction are facile on low-cost carbon or graphite electrodes, which is desirable.

The separator apparatus 116 may operate as is known in the art. See, for example, the teachings embodied in U.S. Pat. No. 11,077,452 B2 entitled “Process, apparatus, and system for recovering materials from batteries,” incorporated herein for reference. As noted above, the separator apparatus 116 separates the recovered materials 118 such as, but not limited to, Cu, Li, Ni, Co, and Mn, discharges any waste streams 120, and passes an enriched concentration of the oxidized reducing agent (R^{ox}) to the second process, which in the illustrated embodiment includes oxidized electrolyte storage tank 130.

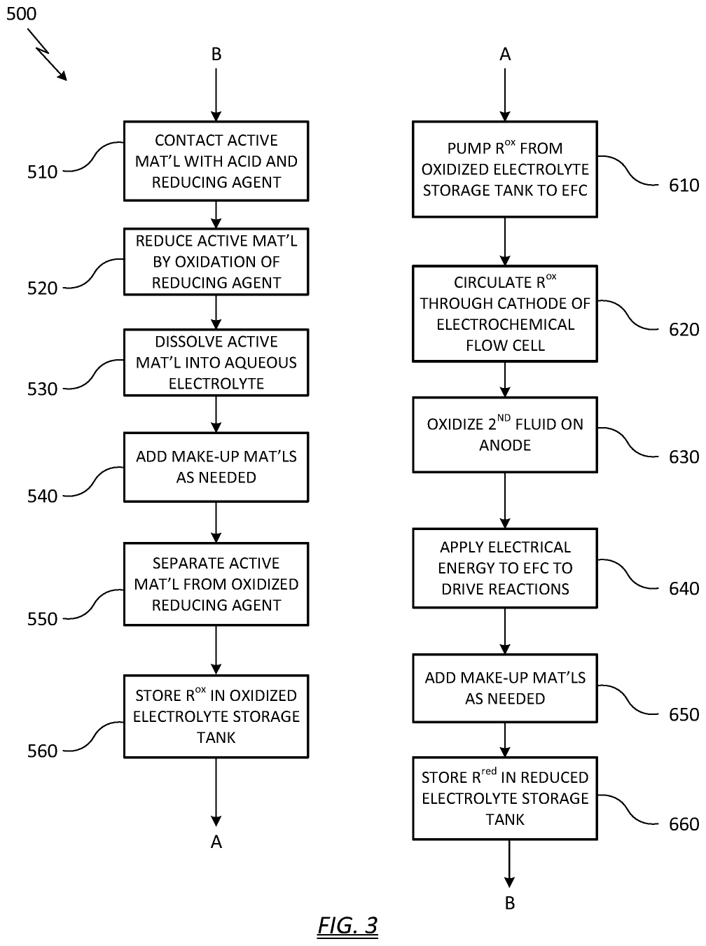

Turning now to FIG. 3, shown is a flowchart for a method 500 for recovering an active material from a rechargeable battery.

The method may be characterized by two processes, which may operate independently. The first process is denoted by steps in the 500 series, and the second process is denoted by steps in the 600 series.

The method includes a step 510 of pumping at least two aqueous solutions into a reactor: 1) a solution with used battery materials, and 2) a solution with reduced electrochemically-active reactant (R^{red}). The battery materials include active material from a used rechargeable battery such as black mass, such as lithium (Li), cobalt (Co), nickel (Ni), copper (Cu), and/or manganese (Mn). The reactant may comprise an acid and a reducing agent. The reactor may be a hydrometallurgical reactor, such as for example, a continuous stirred tank reactor.

The method further includes a step 520 of reducing the active material by oxidation of the reducing agent, and a step 530 of dissolving the active material into the aqueous electrolyte. An optional step 540 includes adding make-up material 148 as needed, such as fresh R^{red} salts or acid. In a step 550, in reactors downstream of the hydrometallurgical reactor, the aqueous solution of leached battery materials is subjected to a variety of known separation methods (e.g., precipitation and filtration) to separate and recover the desired products (e.g., Cu, Li, Ni, Co, and Mn). This results in an aqueous solution that is enriched in concentration of the oxidized reactant (R^{ox}), and this aqueous solution may be directed to and stored in the oxidized electrolyte storage tank at an optional step 560.

The first process may be conducted continuously, as long as there is some aqueous solution with reduced electrochemically-active reactant (R^{red}) available (i.e., the reduced electrolyte storage tank has not been emptied).

The second process includes an optional step 610 of pumping the oxidized reactant (R^{ox}) from the oxidized electrolyte storage tank, if present, to the electrochemical flow cell (EFC). At step 620, the second process further includes circulating the oxidized reducing agent (R^{ox}) in the aqueous electrolyte through a cathode of an electrochemical flow cell. Simultaneously, at a step 630 a second fluid is fed to the anode of the electrochemical flow cell, while at a step 640 electrical energy is supplied to the electrochemical flow cell to drive the desired electrochemical reactions, which is the reduction of R^{ox} to R^{red} and the oxidation of the second fluid. At an optional step 650, make-up material may be added to the oxidized electrolyte storage tank as needed. Then, at an optional step 660, the reducing agent (R^{red}) is discharged from the electrochemical flow cell may be directed to and stored in the reduced electrolyte storage tank.

The second process is may be advantageously conducted whenever desirable electrical energy is available (e.g., low-cost and/or low-carbon, such as electricity generated by renewable sources, like solar photovoltaic or wind).

In one embodiment of the invention, both processes (i.e., recycling black mass in the hydrometallurgical reactor and reducing the reducing agent in the electrochemical flow cell) may be designed to run simultaneously as a single continuous process. In this manner, no large electrolyte storage tanks are required. The embodiment is thought to be novel since acid leaching of lithium-ion battery materials and electrochemical reaction are done continuously, and the electrochemical flow cell is far more efficient, smaller, and cheaper than batch processes.

In another embodiment of the invention, both processes can be run at different rates by using storage tanks to decouple the two processes. The electrochemical process can be designed to be a continuous process (as noted above), or run at higher rate than leaching process and thereby enable intermittent operation of the electrochemical process. This embodiment may be desirable for recycling companies with conventional leaching hardware.

In yet another embodiment of the invention, acids other than sulfuric acid, or mixture of acids, may be used, such as hydrochloric acid, nitric acid, phosphoric acid, or organic acids.

In yet another embodiment of the invention, anion-exchange membranes (AEM) or bipolar membranes may be used instead of cation-exchange membranes, if desired.

In yet another embodiment of the invention, it may be possible to produce useful products may be produced on the anode of electrochemical flow cell. For example, one can oxidize glycerol, which is an otherwise discarded byproduct of biomass conversion processes, to produce formate and/or lactate solutions. Other options are those taught by others in conjugation with CO₂ reduction.

In yet another embodiment of the invention, one can co-locate at a hydrogen production site and use H2 to reduce the reducing agent. If electrolyzer, then this is the primary EES system, and recycling, or at least the electrochemical process, is done whenever excess H2 is available.

One of the improvements of the present disclosure is it minimizes emissions and waste materials relative to other battery-recycling processes. One advantage of the disclosed system is that it reduces capital and operating costs. Another advantage is that it enables using electrical energy that is low-cost and/or low-carbon (e.g., renewable sources).

Key benefits of the disclosed system and process include: (a) the electrochemical cell can be run as a continuous process, not a batch; (b) capital costs are significantly reduced; (c) the electrochemical flow cell enables substantially higher current densities, namely, at 100s of mA/cm², or even >1 A/cm² (versus prior art 10 mA/cm²). This is primarily because the flow cell is designed to minimize mass-transport losses by using forced-convective flow through the electrodes; (d) electrode materials are optimized for desired reactions, (e) the membrane is commercial, off-the-shelf and has lower Ohmic losses than a bipolar membrane; (f) the system may be designed to be retrofitted to existing peroxide-based systems; (g) the system includes the possibility of multiple anode and cathode reaction options; and (h) teaches a method to effectively use electricity from “Clean Energy” sources, which are highly variable (i.e., some type of energy storage is needed).

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A system for recovering an active material from a rechargeable battery, comprising:
a hydrometallurgical reactor configured to contact the active material with an aqueous electrolyte comprising an acid and a reducing agent;
an electrochemical flow cell comprising a cathode, an anode, and a separator disposed therebetween, wherein the cathode receives the aqueous electrolyte, and the anode receives a second fluid; and
a separator apparatus configured to separate and recover the active material from the aqueous electrolyte, and recirculate the aqueous electrolyte to the electrochemical flow cell.

2. The system of claim 1, wherein the reactor is in fluid communication with the electrochemical flow cell.

3. The system of claim 1, further comprising a storage vessel for the aqueous electrolyte with reducing agent, and a second storage vessel for the oxidized reducing agent in the aqueous electrolyte.

4. The system of claim 3, wherein the reactor is configured to operate at a rate that is independent of a rate of operation of the electrochemical flow cell, which is enabled by the volume of aqueous electrolyte in the first and second storage vessels.

5. The system of claim 4, wherein the electrochemical flow cell is configured to operate at higher rates when electricity rates are low and is run at lower rates, or even stopped, when the costs of electricity are high.

6. The system of claim 1, wherein the reducing agent are ferrous ions and the oxidized reducing agent are ferric ions.

7. The system of claim 1, wherein the acid is sulfuric acid.

8. The system of claim 1, wherein the second fluid is water, which is oxidized to form molecular oxygen and protons on the anode.

9. The system of claim 1, wherein the second fluid is hydrogen, which is oxidized to form protons on the anode.

10. The system of claim 1, wherein the active material is black mass from recycled lithium-ion batteries.

11. A method for recovering an active material from a rechargeable battery, the method comprising:
a first process comprising the steps of:
placing the active material from a rechargeable battery in a reactor and contacting the active material with an aqueous electrolyte comprising an acid and a reducing agent;
reducing the active material by oxidation of the reducing agent;
dissolving the active material into the aqueous electrolyte; and
separating the active material from the oxidized reducing agent in the aqueous electrolyte;
and
a second process, comprising the steps of:
circulating the oxidized reducing agent in the aqueous electrolyte through a cathode of an electrochemical flow cell, the electrochemical flow cell comprising the cathode, an anode, and a separator disposed therebetween;
applying a potential to the electrochemical flow cell sufficient to reduce the oxidized reducing agent while simultaneously oxidizing a second fluid on the anode; and
circulating the regenerated aqueous electrolyte with reducing agent from the second process to the reactor in the first process.

12. The method of claim 11, further comprising a first storage vessel for the aqueous electrolyte with reducing agent, and a second storage vessel for the oxidized reducing agent in the aqueous electrolyte.

13. The method of claim 12, wherein the first process is operated at a rate that is independent of the second process, which is enabled by the volume of aqueous electrolyte in the first and second storage vessels.

14. The method of claim 13, wherein the second process is operated at higher rates when electricity rates are low and is run at lower rates, or even stopped, when electricity rates are higher.

15. The method of claim 11, wherein the reducing agent are ferrous ions and the oxidized reducing agent are ferric ions having a concentration within a range of about 0.01M to 2M.

16. The method of claim 11, wherein the acid is sulfuric acid having a concentration within a range of about 0.1M to 5M.

17. The method of claim 11, wherein the second fluid is liquid water, which is oxidized to form molecular oxygen and protons on the anode.

18. The method of claim 11, wherein the second fluid is hydrogen, which is oxidized to form protons on the anode.

19. The method of claim 11, wherein the active material comprises black mass from recycled lithium-ion batteries.

20. The method of claim 19, wherein the black mass comprises at least one of lithium, cobalt, nickel, copper, and manganese.
